(19) United States
(12) Patent Application Publication
(10) Pub. No.: US 2008/0267761 A1
(43) Pub. Date: Oct. 30, 2008

(54) Interleaver Stacker and Loading System

(75) Inventors: Lawrence Ward, Collegeville, PA (US); Allen M. Ely, Downingtown, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: PACKAGING PROGRESSIONS, INC., Collegeville, PA (US)

(21) Appl. No.: 11/996,540

(22) PCT Filed: Aug. 9, 2006
(86) PCT No.: PCT/US06/31068

§ 371 Date: Jan. 23, 2008

(30) Foreign Application Priority Data
Aug. 11, 2005 (US) 60707292
Feb. 10, 2006 (US) 60772008

(51) Int. Cl. B65G 57/00; B31B 17/00

(52) U.S. Cl. 414/788.9; 414/788.1; 414/789.6; 414/802

(57) ABSTRACT

A stacker adapted to generally stack product in a vertical fashion is provided. The stacker includes a first generally vertical conveyor having a first conveyor belt and a first plurality of flights mounted generally perpendicularly to the first conveyor belt. The first plurality of flights at least partially defines a plurality of stacking platforms. At least one positioning sensor for sensing a relative position of the flights is provided. An advancement sensor is provided for sensing product entering the stacker. A first drive incrementally drives the first conveyor responsive to the advancement sensor so that the stacking platforms descend. Each of the stacking platforms can receive individual or single items to be stacked into a tray or can sequentially receive multiple items, either pre-stacked or stacked on a given flight, and then be indexed downwardly to allow the next stack to be formed on the subsequent stacking platform. A method and system for handling and stacking products is also provided.

### FIELD OF THE INVENTION

The present invention is generally directed to stackers. More specifically, the present invention is directed to a stacker that can generally stack product in a vertical fashion at a high rate of speed and an interleaver, stacker and loading system for high speed food packaging.

### BACKGROUND

Many manufacturing processes, particularly food handling processes, require the high speed stacking of products in a vertical fashion. Typically, to prevent the products from sticking together when packaged, refrigerated, and/or frozen, a high-speed paper, film, or foil interleaving system is used in conjunction with the stacker to insert a substrate beneath each individual product, which then serves as a separator between stacked products. The vertically stacked products are then typically loaded into a tray, box, or other container, or conveyed to a packaging machine.

Prior known stackers, for example for hamburger patties, typically run at 150 to 200 patties per minute for a single lane. Newer production techniques, however, allow production of patties at higher speeds for single lanes, for example, speeds of up to about 310 patties per minute. The known prior art stackers cannot keep up with the production speed, and thus the production speed is slowed or the product is split into two lanes for separate stacking. Higher cost or slower production results. It would therefore be desirable to address this with a stacker that allows faster production from the overall system by providing an improved high speed stacker.

### SUMMARY

Briefly stated, the present invention is directed to a stacker adapted to generally stack product in a vertical fashion. The stacker includes a first generally vertical conveyor having a first conveyor belt and a first plurality of flights mounted generally perpendicularly to the first conveyor belt. The first plurality of flights at least partially defines a plurality of stacking platforms. At least one positioning sensor for sensing a relative position of the flights is provided. An advancement sensor is provided for sensing product entering the stacker. A first drive incrementally drives the first conveyor responsive to the advancement sensor so that the stacking platforms descend. Each of the stacking platforms can receive a stack of the items to be stacked, and then be indexed downwardly to allow the next stack to be formed on the subsequent stacking platform.

In another preferred aspect of the invention, the stacker further includes a second generally vertical conveyor having a second conveyor belt and a second plurality of flights mounted generally perpendicularly to the second conveyor belt. The first and second conveyors are mounted opposite each other with the flights on facing sides of the first and second conveyors being generally aligned to define the stacking platforms, which are synchronously moved.

In another aspect, the invention provides a stacking-loading system for stacking and loading a lane of products. The system includes a feed conveyor for providing products in a lane and an interleaver that places a substrate under each of the products as they are carried by the feed conveyor. A stacker for stacking the interleaved product in a generally vertical fashion is provided, which is preferably of the type described above, with either the one or two conveyor belts with the flights defining stacking platforms. A removal conveyor that receives the stacked product from the stacker is also provided.

The invention also provides a method of stacking products which includes:
a. Providing stacker including a first generally vertical conveyor having a first conveyor belt and a first plurality of flights mounted generally perpendicularly to the first conveyor belt, the first plurality of flights at least partially defines a plurality of stacking platforms, at least one positioning sensor for sensing a relative position of the flights, an advancement sensor for sensing product entering the stacker, and a first drive for incrementally driving the first conveyor responsive to the advancement sensor.
b. Sensing a first advancing product with the advancement sensor.
c. Introducing the first advancing product onto a first one of the stacking platforms located in a loading position.
d. Sensing a next advancing product with the advancement sensor.
e. Indexing the stacking platform downwardly.
f. Introducing the next advancing product onto the prior product located on the stacking platform.
g. Repeating steps d., e., and f. until a desired number of the products is located the first one of the stacking platforms.
h. Indexing the first conveyor to bring a next one of the stacking platforms into the loading position.
i. Repeating steps c. through g. for the next one of the stacking platforms; and
j. Unloading stacks of product from the stacking platforms.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a rear elevation view of a currently preferred embodiment of a stacker-loader according to the present invention showing product being dispensed into a tray, box or removal conveyor (not shown), and a stack of product received from a feed conveyor (not shown) supported by opposing, aligned flights;

FIG. 2 is a side elevation view of the stacker of FIG. 1;

FIG. 3 is a top plan view of the stacker of FIG. 1;

FIG. 4A is a top view of an alternative embodiment of a stacker-loader according to the present invention wherein the two vertical conveyors are adjustably mounted for adjustment of the gap between the vertical conveyors to allow the stacking of different sized products;

FIG. 4B is a front end elevation view of the stacker-loader of FIG. 4A;

FIG. 4C is a right side elevation view of the stacker-loader of FIG. 4B; and

FIG. 5 is a top view of an alternative embodiment of a stacker-loader according to the present invention wherein multiple stacker-loaders, each comprised of a single set of descending flight, are offset to stack products from multiple closely spaced lanes of product.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The term “containment space” means “the area bounded on the bottom by flights 220aᵢ, 220bᵢ, on top by flights 220aᵢ₊₁, 220bᵢ₊₁, in the rear by product stop 240, in the front by the feed conveyor, and on the sides by belts 210a, 210b, where i is 0, 1, 2, . . . n−1.” The words “a,” “and,” “one,” as used in the claims and in the corresponding portions of the specification, are defined as including one or more of the referenced item unless specifically stated otherwise. This terminology includes the words above specifically mentioned, derivatives thereof, and words of similar import.

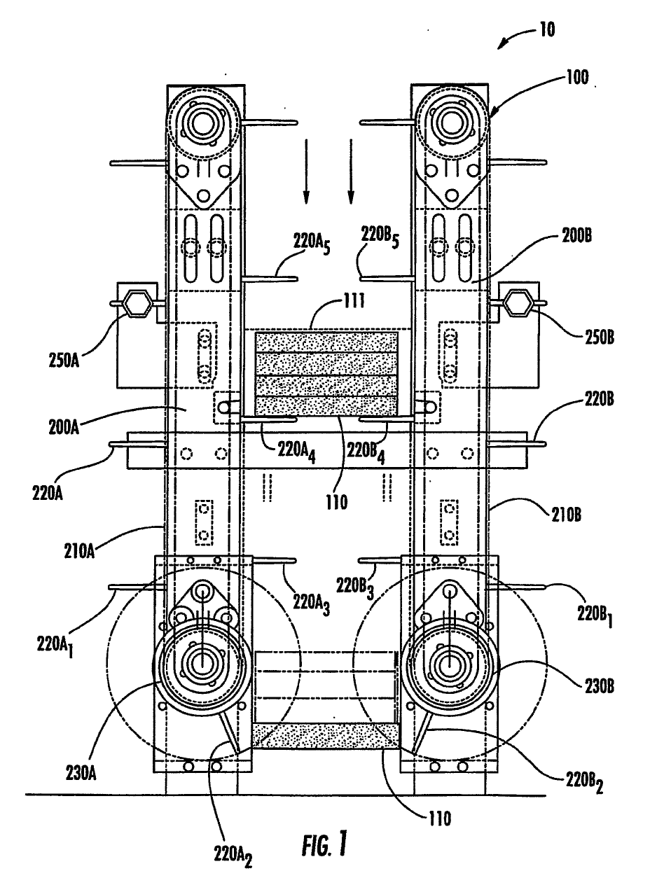

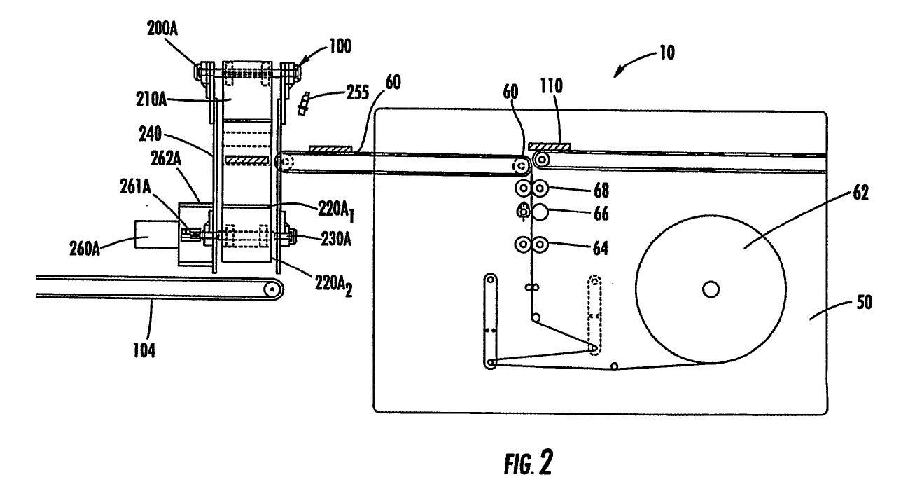

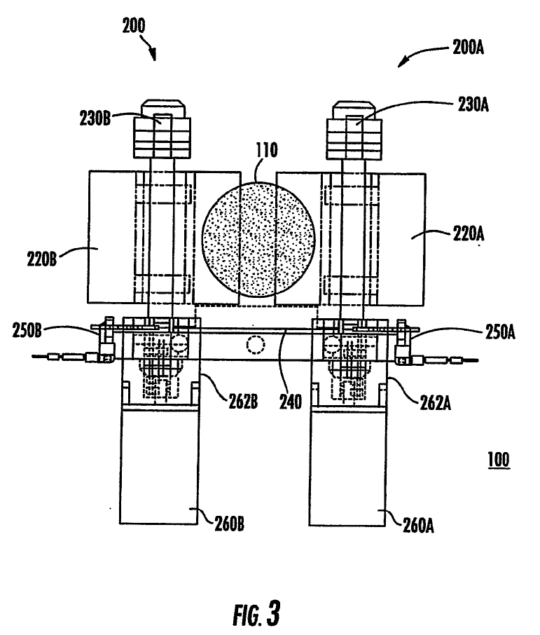

Referring to FIGS. 1-3, wherein like numerals indicate like elements throughout, the presently preferred interleaver, stacker and loading system 10 of the present invention is shown. The system 10 includes an interleaver 50 that interleaves a substrate 60 under product 110, as shown in FIG. 2, as it is transported along a generally horizontal feed conveyor system generally designated 102. The interleaver 50 preferably has a roll of substrate material 62 that is fed between feed rollers 64 to a perforation roller 66 in order to delineate a break line in the continuous sheet of substrate material. Acceleration rollers 68 then accelerate the end of the continuous sheet of substrate so that the piece of substrate to be interleaved is separated from the continuous sheet at the perforation and inserted under the product as it passes over a gap in the conveyor system 102. The interleaving of the substrate 60 can take place based on a photoeye or other product sensor located along the conveyor 102.

The system 10 further includes a stacker, generally designated 100, that receives the preferably interleaved product 110 for generally vertical stacking. Those skilled in the art will understand from the present disclosure that depending on the type of product, it may not be necessary to interleave the product with the substrate 60. A removal conveyor generally designated 104 is also preferably provided, or the stacked product can be placed in boxes or trays directly, which can be conveyed on the removal conveyor 104.

Briefly stated, the horizontal feed conveyor 102 conveys product 110, which can be provided with or without interleaving substrates by the interleaver 50, in a single lane to the stacker 100. The stacker 100 stacks the product 110 and places the stacked product in a tray or box, which is preferably, but not necessarily carried on the removal conveyor, or on the removal conveyor 104. The removal conveyor 104 conveys the stacked product to a packaging machine or an area for further processing.

The stacker 100 is preferably formed by two vertical conveyors 200a, 200b. The conveyors 200a, 200b are preferably positioned parallel to and facing each other. Specifically, the descending side of the belt 210a of conveyor 200a faces the descending side of the belt 210b of conveyor 200b. The conveyors 200a, 200b may alternatively be placed at a slight angle to create a funneling or tapering effect.

The belt 210a, 210b of each respective conveyor 200a, 200b has a plurality of flights, generally 220a, 220b, and more specifically 220a₁, 220a₂ . . . 220aₙ; 220b₁, 220b₂ . . . 220bₙ extending generally perpendicularly outward from the surface of the belt 210a, 210b. Preferably, the total number of flights n is the same on each respective belt 210a, 210b. Furthermore, the relative positioning of the flights 220a₁, 220a₂ . . . 220aₙ of belt 210a are identical to the relative positioning of flights 220b₁, 220b₂ . . . 220bₙ of belt 210b. The flights 220a, 220b on the facing sides of the belts 210a, 210b are aligned, as described hereinafter, directly across from each other to create a series of platforms for the product 110.

The conveyors 200a, 200b are spaced at a distance such that the aligned flights 220a, 220b have a space between them as they are moved in unison to preferably lower the series of platforms, with the space being less than the size of the product being stacked. A drop opening is created as the flights 220a, 220b round the lower roller 230a, 230b of each respective conveyor 200a, 200b. When the drop opening becomes larger than the size of the product 110 or stack of products 111, the product 110 or stack of products 111 passes between the flights 220a, 220b and drops to the removal conveyor 104. The spacing of the conveyors 200a, 200b and the dimension of the flights 220a, 220b can be adjusted to allow the stacker 100 to accommodate varying size products 110.

A product stop 240 is positioned between conveyors 200a, 200b on the rear of the stacker 100. The product stop 240 is positioned in the area of the stacker 100 where product 110 is received from the feed conveyor (not shown). The product stop 240 assists the orderly stacking of product 110 by confining all product 110 to the containment space. The product stop 240 further prevents the product 110 from overshooting the containment space.

The stacker 100 further comprises positioning photoelectric sensors 250a, 250b for sensing the location of each respective conveyor's 210a, 210b flights 220a, 220b. The positioning photoelectric sensors 250a, 250b are preferably mounted on the return (ascending) side of each respective conveyor 200a, 200b, and are vertically adjustable. An advancing product photoelectric sensor 255 is mounted adjacent to the feed conveyor 102 to sense product approaching the stacker 100. While photoelectric sensors are preferred, other types of positioning sensors could be used.

Preferably, the belts 210a, 210b of respective conveyors 200a, 200b are moved by servo drives 260a, 260b. Referring particularly now to FIG. 2, the servo drive 260a drives roller 230a via coupling 261a. A drive mount 262a secures the servo drive 260a to the conveyor 200a. While the preferred embodiment has been described using a servo drive 260a to drive the conveyor 200a, a stepper drive or other incremental drive or incremental drive methods are also usable in the present invention. As referred to hereinafter, the motion of the flights 220a, 220b is such that the containment space is moved downward, unless specifically noted.

The exposed mechanics of the stacker 100 are preferably constructed from stainless steel. Where stainless steel cannot be used, sanitary materials are substituted. Sanitary design is also implemented where possible, such as, for example, reducing crevices, providing smooth, wipeable surfaces, and eliminating horizontal platforms where liquids may pool.

The stacker 100 is preferably controlled by a programmable logic controller (PLC). Other types of control systems are possible such as, for example, a distributed control system (DCS) or other similar control system. The PLC is preferably housed in a water-tight enclosure, such as a NEMA-4X enclosure, for example.

The stacker 100 of the present invention, upon initial startup, identifies the position of flights 220a, 220b in a procedure termed “homing”. The PLC instructs the servo drives 260a, 260b to perform the homing procedure, the characteristics of which are stored at the servo drives 260a, 260b. The servo drives 260a, 260b increment their respective belts 210a, 210b and flights 220a, 220b until the photoelectric sensors 250a, 250b sense the position of a flight. A variable offset distance from the positioning photoelectric sensors 250a, 250b to the sensed flight can be programmed so that products 110 of different thicknesses can be handled by the stacker 100. Upon completion of homing, the stacker 100 is ready to receive product 110 from the feed conveyor.

There are two motion profiles utilized by the stacker 100 for receiving product 110. The first motion profile is termed the stacking sequence. In the stacking sequence, the advancement photoelectric sensor 255 identifies an incoming product, for example a hamburger patty, approaching the stacker 100 on the horizontal feed conveyer at a high rate of speed. Upon sensing the incoming patty, the advancement sensor notifies the PLC of the incoming patty. After a programmed delay to allow the patty to enter and settle into the containment space (if this is the first patty in the group) or on to a previously stacked patty (if this is not the first patty in the group), the PLC instructs the servo drive to increment the flights 220a, 220b a programmed distance. The programmed distance is such that the next patty will come to rest on top of the first patty upon entering the containment space. A stack count, which is simply a count of the number of products 110 which have entered the stacker 100, is then incremented. This stacking sequence is repeated until the adjustable stack count is reached. It should be noted that while the stack count is adjustable, there is an upper limit to the height of the stack inherent in the spacing between flights 220a, 220b.

When the stack count reaches a programmed value, the PLC instructs the servo drive to execute the loading sequence. The loading sequence advances the flights 220a, 220b and stops the motion when the next set of flights is in the loading position, preferably when the positioning photoelectric sensor is triggered. The stack count is then reset to zero. An adjustable, programmable offset is provided for controlling the stopping position of the loading sequence. Additionally, the vertical position of the positioning photoelectric sensors 250a, 250b on each respective conveyor 200a, 200b is adjustable. When the stacker 100 executes the loading sequence, the product 110 or stack of products 111 that has moved to the lowest containment space is dropped onto the removal conveyor 104, as described above. A tray, box or other receptacle may be placed on, or be part of, the removal conveyor 104.

A thickness detecting photoelectric sensor, or other device capable of detecting thickness, can also be employed along the feed conveyor 102 to detect a thickness of product 110 fed into the stacker 100. Using the thickness detector, the travel distance of the flights 220a, 220b during stacking could be adjusted for each individual product 110 to be stacked, if desired. This is especially useful when stacking product that has considerable product thickness variability.

Additionally, depending on the type of product 110 being stacked, the position of the flights 220a, 220b can be adjusted so that the product does not slide from the conveyor system 102 onto the flights 220a, 220b or previously stacked product 110, but rather the flights or previously stacked product 110 are spaced downwardly from the level of the conveyor 102 so that the product 110 being stacked is lofted (i.e. airborne) as it travels onto the flights 220a, 220b or previously stacked product 110. This is especially important for soft or sticky products, such as fresh meat patties. The incremental movement down of the flights 220a, 220b can be pre-set for a particular product thickness for generally uniform thickness products, or can be adjusted based on the use of a product thickness sensor.

In another embodiment of the present invention, the stacker 100 can be used as an up or down elevator to raise or lower single products or stacked products to a higher or lower level in tight spaces. Especially, when space is limited and an inclined conveyor system is not practical.

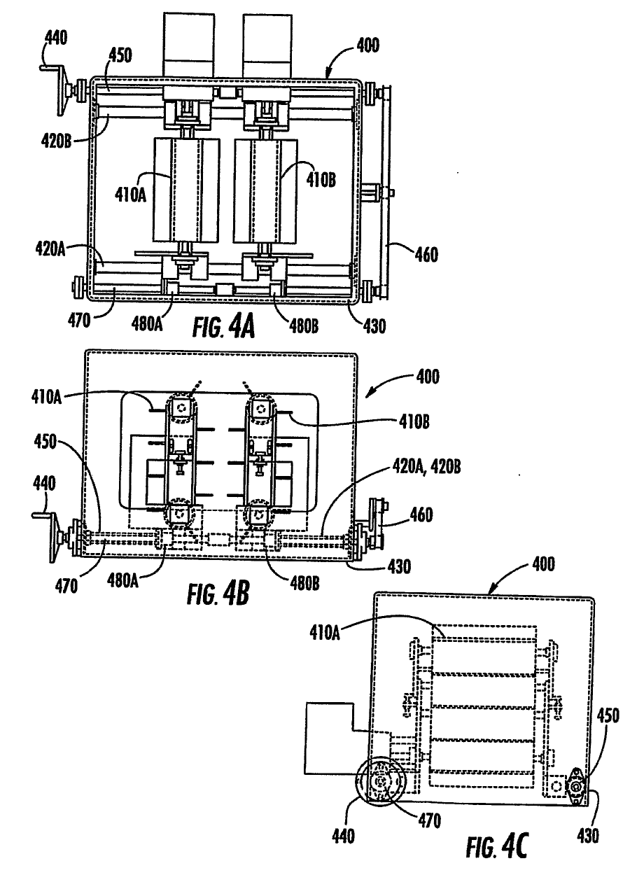

Referring to FIGS. 4A, 4B, and 4C, another embodiment of the present invention in the form of an adjustable width stacker-loader 400 is shown. Two flighted vertical conveyors 410a, 410b, which are similar to conveyors 210a, 210b described above, are adjustably supported for movement towards and away from each other in a controlled manner, preferably by mounting the vertical conveyors 410a, 410b on slide shafts 420a, 420b or other suitable linear guides. A frame 430 supports the slide shafts 420a, 420b. A crank 440 is connected to a first acme screw 450 mounted on the frame 430. A belt or chain 460 is connected from the first acme screw to a second acme screw 470. Attached to each vertical conveyor 410a, 410b are preferably screw couplings 480a, 480b, respectively, that engage the acme screws 450, 470. Turning the crank 440 causes the lateral movement of the vertical conveyors 410a, 410b when the acme screws 450, 470 are turned. In this manner, an operator of the stacker-loader 400 can easily adjust the gap between the vertical conveyors by turning the crank 440, and the stacker-loader 400 can be quickly and easily adjusted to handle stacking and loading of various size products, as desired.

It should be understood by those skilled in the art that although the stacker-loader is depicted as having a manual crank 440 and ball screws 450, 470 for adjusting the spacing between the vertical conveyors 410a, 410b, a servo motor or other manual or automated device for achieving the adjustment can be easily implemented in connection with ball screws or other suitable linear guides and drives. A stacker-loader with automated adjustment of the spacing between the flights may also be equipped with a photoeye for sensing the size of an approaching product, and automatically adjusting the spacing of the vertical conveyors to accommodate the sensed product.

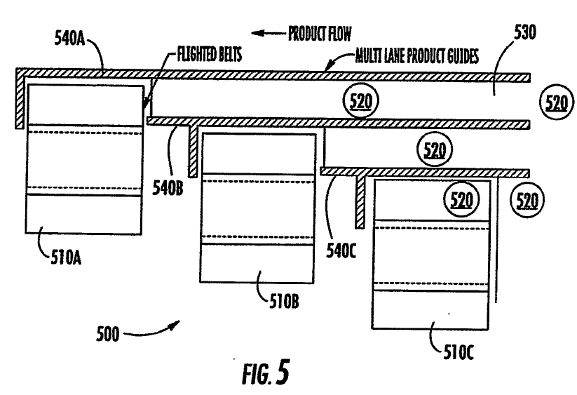

Referring to FIG. 5, another embodiment of the present invention comprising of a multilane stacker-loader 500 is shown. In this embodiment, three single vertical flighted stacking conveyors 510a, 510b, 510c, which are similar to the conveyors 210 and 410a, receive product 520 from a multiple lane feed conveyor 530. Product guides 540a, 540b, and 540c guide the multiple lanes of product 520 approaching the vertical conveyors 510a, 510b, and 510c, respectively, so that the products 520 enter a single flight of a respective vertical conveyor. The vertical conveyors 510a, 510b, and 510c are offset so that the product lanes can be closely spaced together yet still allow for the vertical stacker. One or more exit conveyors or loading stations would be positioned below the stacking conveyors 510a, 510b, 510c to receive the stacked products 520 in the same manner as discussed above in connection with the first embodiment of the invention.

One skilled in the art will recognize that the various automation techniques described above in reference to the single lane stacker can be implemented in this embodiment of the present invention. For example, optical sensors may be positioned along the feed conveyor 530 to detect incoming product 520, as described above. Optical sensors may also be positioned to determine the position of the flights of each vertical conveyor 510A, 510B, 510C, and for stepping the flights by way of a servo motor or other means controlled by a PLC, as described above. An interleaver may be positioned prior to the stacker-loader 500 for placing a substrate under the product 520 to be stacked, as described above. It should be understood that while three vertical conveyors are shown in FIG. 5, this is merely exemplary, and the number of vertical conveyors can be selected as desired.

It will be recognized by those skilled in the art that changes may be made to the above described embodiments of the invention without departing from the broad inventive concept thereof. For example, the conveyers 200a, 200b need not be mounted vertically, but instead slightly offset from vertical. Similarly, the spacing of the flights 220a, 220b need not be uniform, thereby allowing stacking of various sized products. Additionally, for single flight stacking, such as using the stacking conveyors 510a, 510b, 510c, the product can hang over the edge of the flight to some extent. While a preferred embodiment of a stacker is shown, any conveyor having rollers can be used in conjunction with the system provided by the present invention.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A stacker adapted to generally stack product in a vertical fashion, the stacker comprising:
a. a first generally vertical conveyor having a first conveyor belt and a first plurality of flights mounted generally perpendicularly to the first conveyor belt, wherein the first plurality of flights at least partially defines a plurality of stacking platforms;
b. at least one positioning sensor for sensing a relative position of the flights;
c. an advancement sensor for sensing product entering the stacker; and
d. a first drive for incrementally driving the first conveyor responsive to the advancement sensor so that the stacking platforms descend.

2. The stacker of claim 1, further comprising a second generally vertical conveyor having a second conveyor belt and a second plurality of flights mounted generally perpendicularly to the second conveyor belt, the first and second conveyors being mounted opposite each other with the flights on facing sides of the first and second conveyors being generally aligned to define the stacking platforms.

3. The stacker of claim 2, further comprising a second drive for incrementally driving the second conveyor responsive to the advancement sensor so that the stacking platforms defined by the first and second pluralities of flights descend.

4. The stacker of claim 2, wherein the first drive drives the first and second conveyors.

5. The stacker of claim 1, further comprising a product stop located adjacent to the flights.

6. The stacker of claim 2, further comprising a linear guide, wherein the first and second generally vertical conveyors are mounted upon the linear guide for adjusting a gap between the first and second generally vertical conveyors.

7. The stacker of claim 6, further comprising an adjustment mechanism for laterally moving the first and second generally vertical conveyors for adjusting the gap.

8. The stacker of claim 2, further comprising:
the at least one positioning sensor comprising first and second flight positioning sensors that identify a respective position of one of the first plurality of flights and one of the second plurality of flights and provide positioning signals; and
a controller that receives the positioning signals and controls the first and second conveyors to align the flights on the facing sides of the first and second conveyors.

9. The stacker of claim 8, wherein the controller also receives signals from the advancement sensor and controls the first and second conveyors to incrementally lower the stacking platforms.

10. The stacker of claim 8, further comprising a product thickness detector which detects a product thickness and provides a thickness signal to the controller, and the controller receives the product thickness signal and controls the first and second conveyors to incrementally lower the stacking platforms by at least the detected product thickness.

11. A stacking-loading system for stacking and loading a lane of products, the system comprising:
a. a feed conveyor for providing products in a lane;
b. an interleaver that places a substrate under each of the products as they are carried by the feed conveyor;
c. a stacker for stacking the interleaved product in a generally vertical fashion comprising:
i. a first vertical conveyor having a first conveyor belt with a first plurality of flights mounted generally perpendicularly to the first conveyor belt, wherein each of the first plurality of flights at least partially defines a stacking platform;
ii. at least one positioning sensor for sensing a relative position of the flights;
iii. an advancement sensor for sensing product entering the stacker; and
iv. a first drive for incrementally driving the first conveyor responsive to the advancement photoelectric sensor so that the stacking platform descends; and
d. a removal conveyor that receives the stacked product from the stacker.

12. The stacking-loading system of claim 11, wherein the stacker further comprises a second generally vertical conveyor having a second conveyor belt and a second plurality of flights mounted generally perpendicularly to the second conveyor belt, the first and second conveyors being mounted opposite each other with the flights on facing sides of the first and second conveyors being generally aligned to define the stacking platforms.

13. The stacking-loading system of claim 12, further comprising a second drive for incrementally driving the second conveyor responsive to the advancement sensor so that the stacking platforms defined by the first and second pluralities of flights descend.

14. The stacking-loading system of claim 12, further comprising a linear guide, wherein the first and second generally vertical conveyors are mounted upon the linear guide for adjusting a gap between the first and second generally vertical conveyors.

15. The stacking-loading system of claim 12, further comprising:
the at least one positioning sensor comprising first and second flight positioning sensors that identify a respective position of one of the first plurality of flights and one of the second plurality of flights and provide positioning signals; and
a controller that receives the positioning signals and controls the first and second conveyors to align the flights on the facing sides of the first and second conveyors.

16. The stacking loading system of claim 11, wherein there are a plurality of lanes and a plurality of the stackers, with one of the stackers being assigned to each lane.

17. A method of stacking products, comprising
a. providing stacker including a first generally vertical conveyor having a first conveyor belt and a first plurality of flights mounted generally perpendicularly to the first conveyor belt, the first plurality of flights at least partially defines a plurality of stacking platforms, at least one positioning sensor for sensing a relative position of the flights, an advancement sensor for sensing product entering the stacker, and a first drive for incrementally driving the first conveyor responsive to the advancement sensor;
b. sensing a first advancing product with the advancement sensor;
c. introducing the first advancing product onto a first one of the stacking platforms located in a loading position;
d. sensing a next advancing product with the advancement sensor;
e. indexing the stacking platform downwardly;
f. introducing the next advancing product onto the prior product located on the stacking platform;
g. repeating steps d., e., and f. until a desired number of the products is located the first one of the stacking platforms;
h. indexing the first conveyor to bring a next one of the stacking platforms into the loading position;
i. repeating steps c. through g. for the next one of the stacking platforms; and
i. unloading stacks of product from the stacking platforms.

18. The method of claim 17, wherein the introducing of the first and the next advancing products includes lofting the products onto the stacking platform or a prior product located on the stacking platform.
